(19) United States
(12) Patent Application Publication
(10) Pub. No.: US 2016/0366434 A1
(43) Pub. Date: Dec. 15, 2016

(54) MOTION ESTIMATION APPARATUS AND METHOD

(71) Applicant: ELECTRONICS AND TELECOMMUNICATIONS RESEARCH INSTITUTE, Daejeon (KR)

(72) Inventors: Seong-Mo PARK, Daejeon (KR); Kyung-Jin BYUN, Daejeon (KR); Nak-Woong EUM, Daejeon (KR)

(21) Appl. No.: 15/007,951

(22) Filed: Jan. 27, 2016

(30) Foreign Application Priority Data
Jun. 15, 2015 (KR) 10-2015-0084061

(51) Int. Cl. H04N 19/513

(52) U.S. Cl. CPC H04N 19/513

(57) ABSTRACT

Disclosed herein are motion estimation apparatus and method. The motion estimation apparatus may determine an SAD of a coding unit in a current image and calculate an average SAD of the current image. The motion estimation apparatus may compare the SAD of the coding unit with the average SAD of the current image, and determine the number of one or more previous images to be used for motion estimation of the coding unit based on the results of comparison.

### CROSS REFERENCE TO RELATED APPLICATION

This application claims the benefit of Korean Patent Application No. 10-2015-0084061, filed Jun. 15, 2015, which is hereby incorporated by reference in its entirety into this application.

### BACKGROUND OF THE INVENTION

1. Technical Field

The following embodiments generally relate to video coding and, more particularly, to a method and apparatus for estimating the motion of a coding unit.

2. Description of the Related Art

As an existing multimedia video compression standard, there is H.264/Advanced Video Coding (H.264/AVC). H.264 was developed by Moving Picture Experts Group (MPEG) of the International Organization for Standardization (ISO)/International Electrotechnical Commission (IEC), and Video Coding Experts Group (VCEG) of the International Telecommunication Union Telecommunication Standardization Sector (ITU-T) in collaboration with each other. Further, H.264 was adopted as a standard in 2005.

As a next-generation multimedia video compression standard, there is High Efficiency Video Coding (HEVC). HEVC is a next-generation video encoding/decoding standard, and enables the processing of ultra-high definition video such as 8K and 4K video. The Joint Collaborative Team on Video Coding (JCT-VC) was organized by MPEG of ISO/IEC and VCEG of ITU-T organized in January 2010, and JCT-VC was established to work on HEVC. The HEVC standard was completed in 2012, and the HEVC Test Model (HM) version 16.0 was published up to August 2012.

One object of HEVC is to achieve compressibility that is twice that of H.264. In other words, one object of HEVC is to achieve very high compressibility, and the standardization of HEVC is being conducted to satisfy such an object.

HEVC denotes universal video coding technology that is usable in the environment of almost all transfer media including storage media, the Internet, and satellite broadcasting, and the environment having various video resolutions.

Typically, for the international standards of ITU, video coding standards based on wired communication media have been established. As such video coding standards, there are H.261, H.263, and H.264. MPEG of ISO/IEC has established video coding standards for video processing on storage media and broadcasting media. As such video coding standards, there are MPEG-1 and MPEG-2.

Further, MPEG has completed the establishment of an MPEG-4 video standard. MPEG-4 is a coding standard supported over all multimedia. One feature of MPEG-4 is object-based video coding. Further, MPEG-4 has realized various functions and high compressibility.

VCEG of ITU successively established a video standard having high compressibility under the name of H.26L even after the establishment of the MPEG-4 video standard. In formal comparative experiments of MPEG, H.26L exhibited superiority over MPEG-4 video standards having similar functions from the standpoint of compressibility. Depending on such results, MPEG has developed H.264/AVC, which is a Joint Video Team (JVT) video standard based on H.26L, in collaboration with VCEG group of ITU.

To implement an operation of compressing video data using a compression algorithm in hardware, a System on a Chip (SoC) is used. In current markets, a SoC enabling video processing with ultra-high definition and high resolution is required. When video coding technology, such as HEVC, is implemented in SoC, the traffic of multimedia data increases between external memory and the internal memory of SoC as the resolution of video increases. In this case, a problem arises in that the performance of SoC is deteriorated due to the increased data traffic.

Standards were established in such a way as to use various coding units in a motion estimation (prediction) block having the highest computational load among component blocks that implement HEVC.

HEVC uses coding units having various coding unit sizes such as 64×64, 32×32, 16×16, and 8×8. Compared to existing H.264 in which the maximum size of a macro block is 16×16, HEVC enables video to be processed on a large macro block basis by exploiting a 64×64 large coding unit.

To process video on a large macro block basis, a high computational load is required. In particular, when HEVC is implemented in SoC, a problem arises in that performance is deteriorated and high power consumption is caused due to large-macro block-based processing. Further, when several reference images are used, a problem occurs in bandwidth for memory access.

In conventional technology, an encoder is designed to read data of reference images required for motion estimation from external memory. In this design, since the number of read reference images is limited, there is a problem that the quality of video is deteriorated.

### SUMMARY OF THE INVENTION

An embodiment is intended to provide a motion estimation apparatus and method, which can improve the quality of a video while using relatively low memory bandwidth by adaptively selecting the number of reference images.

Another embodiment is intended to provide a motion estimation apparatus and method, which efficiently read previous images required for motion estimation by adaptively selecting the number of reference images.

In accordance with an aspect, there is provided a motion estimation apparatus, including a selection unit for determining an attribute value of a coding unit in a current image; and a determination unit for determining a number of one or more previous images to be used for motion estimation of the coding unit, based on the attribute value of the coding unit.

The attribute value may be a Sum of Absolute Difference (SAD) of the coding unit.

The determination unit may determine the number of one or more previous images to be used for motion estimation of the coding unit, based on the SAD of the coding unit.

The motion estimation apparatus may further include an average SAD calculation unit for calculating an average SAD of the current image.

The determination unit may determine the number of one or more previous images to be used for motion estimation of the coding unit, based on a comparison between the SAD of the coding unit and the average SAD of the current image.

The determination unit may be configured to, when the SAD of the coding unit is greater than the average SAD of the current image, determine the number of one or more previous images to be used for motion estimation of the coding unit to be 1, and when the SAD of the coding unit is less than or equal to the average SAD of the current image, determine the number of one or more previous images to be used for motion estimation of the coding unit to be 2 or more.

The motion estimation apparatus may further include a motion vector determination unit for generating multiple motion vectors related to the coding unit.

The selection unit may determine the SAD of the coding unit by selecting a minimum motion vector, from among motion vectors of a plurality of coding units corresponding to the coding unit, out of multiple coding units having multiple coding unit sizes in the current image.

The motion vector determination unit may determine, in parallel, motion vectors of multiple coding units in the current image, for two or more of multiple different coding unit sizes.

The motion estimation apparatus may further include a processing element array for calculating SAD values of multiple coding units in the current image, for multiple different coding unit sizes.

The multiple motion vectors may be determined based on the SAD values of the multiple coding units.

The processing element array may calculate, in parallel, SAD values of multiple coding units in the current image, for two or more of the multiple different coding unit sizes.

The processing element array may calculate, in parallel, SAD values of multiple coding units in the current image, for N×N, 2N×N, and N×2N coding unit sizes of the multiple different coding unit sizes.

The N×N coding unit size may include 64×64, 32×32, 16×16, and 8×8 sizes.

The 2N×N coding unit size may include 64×32, 32×16, 16×8, and 8×4 sizes.

The N×2N coding unit size may include 32×64, 16×32, 8×16, and 4×8 sizes.

The processing element array may include an N×N processing element array for calculating SAD values of multiple coding units in the current image for an N×N coding unit size; a 2N×N processing element array for calculating SAD values of multiple coding units in the current image for a 2N×N coding unit size; and a N×2N processing element array for calculating SAD values of multiple coding units in the current image for an N×2N coding unit size.

The N×N processing element array, the 2N×N processing element array, and the N×2N processing element array may calculate, in parallel, SAD values for the N×N, 2N×N, and N×2N coding unit sizes.

The motion estimation apparatus may further include current image memory for storing the current image; and previous image memory for storing a previous image that is an image previous to the current image.

The SAD values may be generated based on the current image and the previous image.

The motion estimation apparatus may further include an address generation unit for determining a memory address of the previous image.

The motion estimation apparatus may further include a motion estimation unit for estimating motion of the coding unit using the one or more previous images.

The motion estimation unit may estimate motion of the coding unit using integer motion estimation if the number of one or more previous images is two or more.

In accordance with another aspect, there is provided a method for determining a number of one or more previous images to be used for motion estimation of a coding unit, including determining a SAD of a coding unit in a current image; calculating an average SAD of the current image; and determining a number of one or more previous images to be used for motion estimation of the coding unit, based on the SAD of the coding unit and the average SAD of the current image.

When the SAD of the coding unit is greater than the average SAD of the current image, one previous image may be used for motion estimation of the coding unit, whereas when the SAD of the coding unit is less than or equal to the average SAD of the current image, two or more previous images may be used for motion estimation of the coding unit.

In accordance with a further aspect, there is provided a motion estimation method, including determining an attribute value of a coding unit in a current image; determining a number of one or more previous images to be used for motion estimation of the coding unit, based on the attribute value of the coding unit; and estimating motion of the coding unit using the one or more previous images.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a motion estimation apparatus according to an embodiment;

FIG. 2 is a flowchart showing a motion estimation method according to an embodiment;

FIG. 3 is a flowchart showing a method of determining the number of one or more previous images to be used for the motion estimation of a coding unit according to an embodiment;

FIG. 4 is a flowchart showing a method for estimating the motion of a target coding unit using one or more previous images according to an embodiment;

FIG. 5A illustrates a current image composed of a coding unit having 64×64 coding unit size according to an embodiment;

FIG. 5B illustrates a current image composed of coding units having 32×32 coding unit size according to an embodiment;

FIG. 5C illustrates a current image composed of coding units having 16×16 coding unit size according to an embodiment;

FIG. 5D illustrates a current image composed of coding units having an 8×8 coding unit size according to an embodiment;

FIG. 6A illustrates a current image composed of coding units having 64×32 coding unit size according to an embodiment;

FIG. 6B illustrates a current image composed of coding units having 32×16 coding unit size according to an embodiment;

FIG. 6C illustrates a current image composed of coding units having 16×8 coding unit size according to an embodiment;

FIG. 6D illustrates a current image composed of coding units having an 8×4 coding unit size according to an embodiment;

FIG. 7A illustrates a current image composed of coding units having 32×64 coding unit size according to an embodiment;

FIG. 7B illustrates a current image composed of coding units having 16×32 coding unit size according to an embodiment;

FIG. 7C illustrates a current image composed of coding units having an 8×16 coding unit size according to an embodiment;

FIG. 7D illustrates a current image composed of coding units having 4×8 coding unit size according to an embodiment; and

FIG. 8 illustrates the results of simulation depending on the number of reference images according to an embodiment.

### DESCRIPTION OF THE PREFERRED EMBODIMENTS

The following detailed descriptions of the present invention will be made with reference to the attached drawings that illustrate specific embodiments in which the present invention can be practiced. These embodiments will be described in detail so that those skilled in the art can sufficiently practice the present invention. It should be understood that various embodiments of the present invention may differ, but they do not need to be exclusive. For example, specific shapes, structures and characteristics described herein in an embodiment may be implemented in various manners in other embodiments without departing from the spirit and scope of the present invention. Further, it should be understood that the locations and arrangements of individual elements in each disclosed embodiment may be changed without departing from the spirit and scope of the present invention. Therefore, the following detailed descriptions are not intended to limit the present disclosure, and the scope of the present invention should be limited only by the accompanying claims along with all equivalent scopes of the claims as long as it is suitably described. The same or similar reference numerals are used to designate the same or similar elements or functions throughout the drawings.

Hereinafter, exemplary embodiments of the present invention will be described in detail with reference to the attached drawings so that those skilled in the art to which the present invention pertains can easily practice the present invention.

In the following description, the term “image” may also be used to have the same meaning as the term “frame”. Further, the terms “image” and “frame” may be exchanged and used with each other.

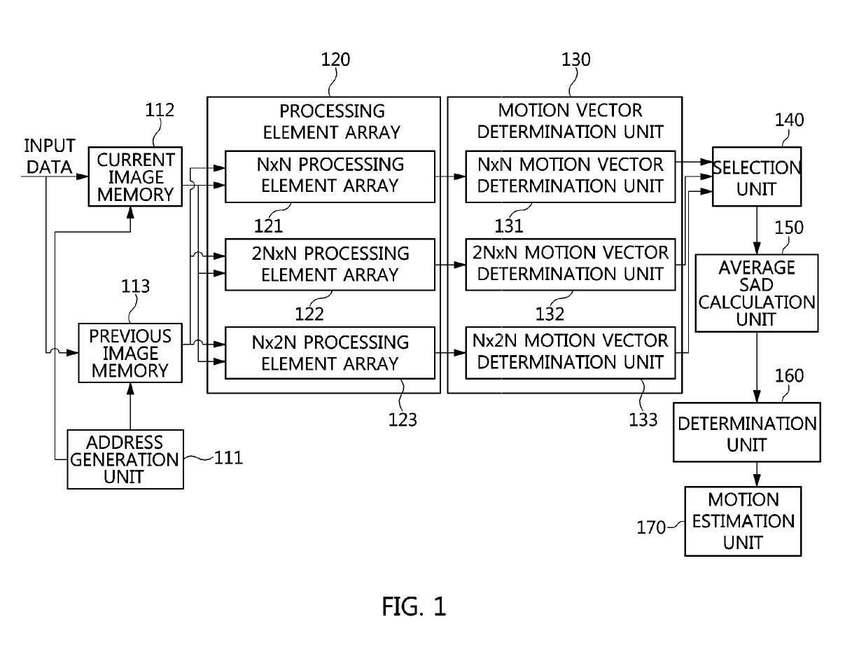

FIG. 1 is a block diagram showing a motion estimation apparatus according to an embodiment.

A motion estimation apparatus 100 may be a device for estimating (or predicting) the motion of a coding unit. Further, the motion estimation apparatus 100 may be at least a part of the encoder or decoder of HEVC and may perform motion estimation of HEVC.

The motion estimation apparatus 100 may include an address generation unit 111, current image memory 112, previous image memory 113, a processing element array 120, a motion vector determination unit 130, a selection unit 140, an average Sum of Absolute Difference (SAD) calculation unit 150, a determination unit 160, and a motion estimation unit 170.

The processing element array 120 may include an N×N processing element array 121, a 2N×N processing element array 122, and an N×2N processing element array 123.

The motion vector determination unit 130 may include an N×N motion vector determination unit 131, a 2N×N motion vector determination unit 132, and an N×2N motion vector determination unit 133.

At least some of the address generation unit 111, the current image memory 112, the previous image memory 113, the processing element array 120, the motion vector determination unit 130, the selection unit 140, the average SAD calculation unit 150, the determination unit 160, and the motion estimation unit 170 of the motion estimation apparatus 100 may be program modules, which are capable of communicating with external devices or systems. Such program modules may be included in the motion estimation apparatus 100 in the form of an operating system, an application program module, or an additional program module, and may be physically stored in various types of well-known storage devices. Further, at least some of the program modules may be stored in a remote storage device capable of communicating with the motion estimation apparatus 100. Such program modules may include, but are not limited to, a routine, a subroutine, a program, an object, a component, and a data structure for performing specific functions or operations, which will be described later, according to the present invention or for executing specific abstract data types. Each of the program modules may be implemented using instructions or codes that are executed by at least one processor of the motion estimation apparatus 100.

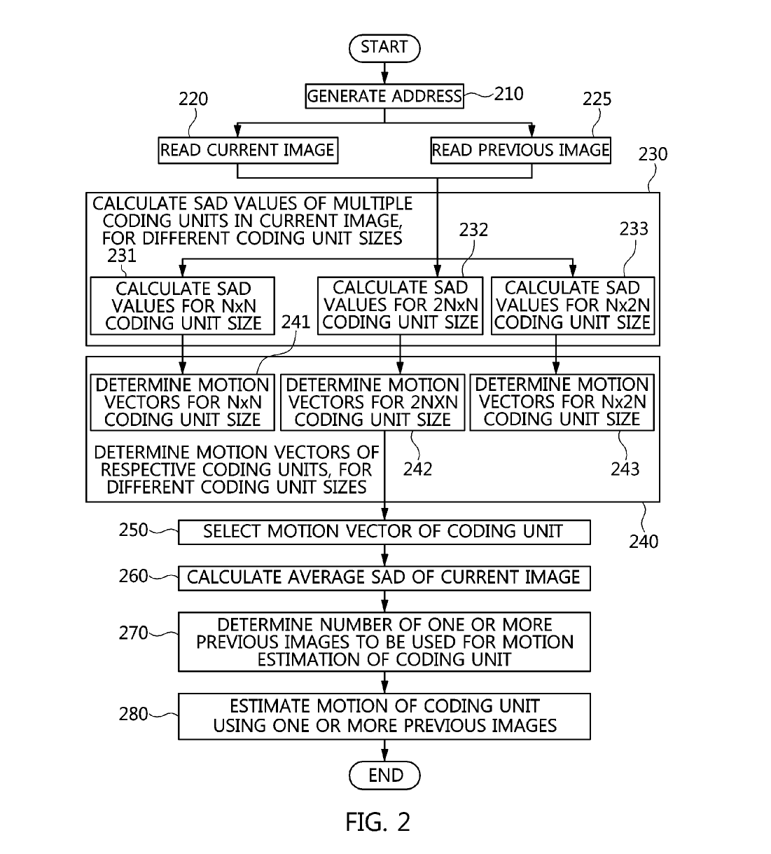

The operations and functions of the above-described components, that is, the address generation unit 111, the current image memory 112, the previous image memory 113, the processing element array 120, the motion vector determination unit 130, the selection unit 140, the average SAD calculation unit 150, the determination unit 160, and the motion estimation unit 170 are described in detail with reference to FIGS. 2 to 4.

FIG. 2 is a flowchart showing a motion estimation method according to an embodiment.

At step 210, the address generation unit 111 may determine the address of a current image and the address of a previous image. The previous image may be the image previous to the current image. For example, when the current image is the image at time t, the previous image may be the image at time t−1.

The address of a current image may indicate the location of a current image in external memory. The address of a previous image may indicate the location of a previous image in the external memory.

The address generation unit 111 may provide the address of the current image to the current image memory 112. The address generation unit 111 may provide the address of the previous image to the previous image memory 113.

At step 220, the current image memory 112 may read a current image from the external memory using the address of the current image. The current image memory 112 may store the current image and may provide the current image to the processing element array 120.

At step 225, the previous image memory 113 may read the previous image from the external memory using the address of the previous image. The previous image memory 113 may store the previous image and provide the previous image to the processing element array 120.

At step 230, the processing element array 120 may calculate SAD values of multiple coding units in the current image, for multiple different coding unit sizes.

The SAD values may be stored in a register for SAD, and the motion estimation apparatus 100 may further include a register for storing SAD values. The register may be used in order for the processing element array 120, the motion vector determination unit 130, and the selection unit 140 to access SAD values at high speed.

The current image may be divided into multiple coding units having a predetermined coding unit size. The coding unit size may have multiple sizes. In other words, the current image may be composed of multiple coding units having a predetermined coding unit size.

For example, the coding unit size may include at least one of 64×64, 32×32, 16×16, 8×8, 64×32, 32×16, 16×8, 8×4, 32×64, 16×32, 8×16, and 4×8. A 64×64 coding unit may be a Larger Coding Unit (LCU).

The processing element array 120 may calculate SAD values of each coding unit in the current image, for each of multiple different coding unit sizes.

The SAD values calculated for each coding unit may include multiple values. The multiple SAD values may correspond to multiple motion vectors, respectively.

Such a SAD may be generated based on the current image and the previous image. The processing element array 120 may calculate an SAD between the coding unit in the current image and the corresponding region in the previous image. The processing element array 120 may calculate SAD values of the coding unit, for each of a plurality of location differences falling within a predetermined range. Here, the location difference may denote the difference between the location of the coding unit in the current image and the location of the corresponding region in the previous image.

For example, the location of the coding unit in the current image and the location of the corresponding region in the previous image may be identical to each other. The SAD calculated for the location difference at this time may correspond to a motion vector (0, 0). Further, for example, the location of the coding unit in the current image may be a location at which it is moved from the location of the corresponding region in the previous image by 1 in the positive direction of an x axis. The SAD calculated for such a location difference may correspond to a motion vector (1, 0). Therefore, the processing element array 120 may calculate an SAD between the coding unit and the corresponding region for each of one or more location differences falling within a predetermined range. Further, the processing element array 120 may calculate multiple SAD values of each of one or more coding units in the current image, for each of the coding unit sizes.

The processing element array 120 may calculate SAD values of multiple coding units in the current image in parallel, for two or more of multiple different coding unit sizes.

The processing element array 120 may calculate SAD values of multiple coding units in the current image in parallel, for an N×N coding unit size, a 2N×N coding unit size, and an N×2N coding unit size among multiple different coding unit sizes.

The coding unit sizes may be divided into three groups. The first group, that is, the N×N coding unit size, may include 64×64, 32×32, 16×16, and 8×8 sizes. The second group, that is, the 2N×N coding unit size, may include 64×32, 32×16, 16×8, and 8×4 sizes. The third group, that is, the N×2N coding unit size, may include 32×64, 16×32, 8×16, and 4×8 sizes.

Steps 230 may include steps 231, 232, and 233.

At step 231, the N×N processing element array 121 calculate SAD values of coding units having an N×N coding unit size in the current image.

For example, the N×N processing element array 121 may calculate SAD values of each of multiple coding units in the current image, for 64×64, 32×32, 16×16, and 8×8 coding unit sizes.

At step 232, the 2N×N processing element array 122 may calculate SAD values of coding units having a 2N×N coding unit size in the current image.

For example, the 2N×N processing element array 122 may calculate SAD values of each of multiple coding units in the current image, for 64×32, 32×16, 16×8, and 8×4 coding unit sizes.

At step 233, the N×2N processing element array 123 may calculate SAD values of coding units having an N×2N coding unit size in the current image.

For example, the N×2N processing element array 123 may calculate SAD values of each of multiple coding units in the current image, for 32×64, 16×32, 8×16, and 4×8 coding unit sizes.

Steps 231, 232, and 233 may be simultaneously performed in parallel. The N×N processing element array 121, the 2N×N processing element array 122, and the N×2N processing element array 123 may calculate, in parallel, SAD values of multiple coding units in the current image, for N×N, 2N×N, and N×2N coding unit sizes, respectively.

Further, steps 231, 232, and 233 may be iteratively performed for multiple coding unit sizes. By means of multiple iterations, the N×N processing element array 121, the 2N×N processing element array 122, and the N×2N processing element array 123 may calculate SAD values of multiple coding units in the current image, for multiple coding unit sizes, respectively.

For example, in a first iteration, the N×N processing element array 121 may calculate SAD values of multiple coding units in the current image for a 64×64 coding unit size, the 2N×N processing element array 122 may calculate SAD values of multiple coding units in the current image for a 64×32 coding unit size, and the N×2N processing element array 123 may calculate SAD values of multiple coding units in the current image for a 32×64 coding unit size. In a second iteration, the N×N processing element array 121 may calculate SAD values of multiple coding units in the current image for a 32×32 coding unit size, the 2N×N processing element array 122 may calculate SAD values of multiple coding units in the current image for a 32×16 coding unit size, and the N×2N processing element array 123 may calculate SAD values of multiple coding units in the current image for a 16×32 coding unit size. In a third iteration, the N×N processing element array 121 may calculate SAD values of multiple coding units in the current image for a 16×16 coding unit size, the 2N×N processing element array 122 may calculate SAD values of multiple coding units in the current image for a 16×8 coding unit size, and the N×2N processing element array 123 may calculate SAD values of multiple coding units in the current image for an 8×16 coding unit size. In a fourth iteration, the N×N processing element array 121 may calculate SAD values of multiple coding units in the current image for an 8×8 coding unit size, the 2N×N processing element array 122 may calculate SAD values of multiple coding units in the current image for an 8×4 coding unit size, and the N×2N processing element array 123 may calculate SAD values of multiple coding units in the current image for a 4×8 coding unit size.

In other words, the processing element array 120 may support partial parallel processing for coding units having all of 12 coding unit sizes that include a 64×64 coding unit size corresponding to the LCU. By means of partial parallel processing, the processing element array 120 may improve performance for various coding unit sizes using relatively small hardware resources. By using relatively small hardware resources, the motion estimation apparatus 100 may reduce an area occupied by hardware while exhibiting performance suitable for HEVC and ultra-high definition images.

At step 240, the motion vector determination unit 130 may determine motion vectors of multiple coding units in the current image, for multiple different coding unit sizes.

As described above, for each coding unit size, the current image may be composed of multiple coding units. Further, at the above-described step 230, for each coding unit size, the processing element array 120 may calculate multiple SAD values of each of multiple coding units in the current image.

The motion vector determination unit 130 may identify a minimum SAD among multiple SAD values of each coding unit, and may determine the motion vector corresponding to the identified minimum SAD to be the motion vector of the corresponding coding unit. The identified minimum SAD may be a final SAD of the coding unit.

For example, at the above-described step 230, for a coding unit having a 64×64 coding unit size which constitute a current image, the processing element array 120 may calculate SAD values of the coding unit for multiple location differences. The motion vector determination unit 130 may determine the motion vector of the coding unit having the 64×64 coding unit size by comparing the calculated SAD values with each other. Further, in a similar manner, the motion vector determination unit 130 may determine the motion vector of a coding unit having a 64×32 coding unit size, and determine the motion vector of a coding unit having a 32×64 coding unit size.

Step 240 may include steps 241, 242, and 243.

At step 241, the N×N motion vector determination unit 131 may determine motion vectors of coding units having an N×N coding unit size in the current image.

For example, the N×N motion vector determination unit 131 may determine motion vectors of each of multiple coding units in the current image, for 64×64, 32×32, 16×16, and 8×8 coding unit sizes.

At step 242, the 2N×N motion vector determination unit 132 may determine motion vectors of coding units having a 2N×N coding unit size in the current image.

For example, the 2N×N motion vector determination unit 132 may determine motion vectors of each of multiple coding units in the current image, for 64×32, 32×16, 16×8, and 8×4 coding unit sizes.

At step 243, the N×2N motion vector determination unit 133 may determine motion vectors of coding units having an N×2N coding unit size in the current image.

For example, the N×2N motion vector determination unit 133 may determine motion vectors of each of multiple coding units in the current image, for 32×64, 16×32, 8×16, and 4×8 coding unit sizes.

Steps 241, 242, and 243 may be simultaneously performed in parallel. The N×N motion vector determination unit 131, the 2N×N motion vector determination unit 132, and the N×2N motion vector determination unit 133 may determine, in parallel, motion vectors of multiple coding units in the current image, for N×N, 2N×N, and N×2N coding unit sizes, respectively.

Furthermore, steps 241, 242, and 243 may be iterated for multiple coding unit sizes. By means of multiple iterations, the N×N motion vector determination unit 131, the 2N×N motion vector determination unit 132, and the N×2N motion vector determination unit 133 may determine the motion vectors of multiple coding units in the current image, for multiple coding unit sizes.

For example, in a first iteration, the N×N motion vector determination unit 131 may determine motion vectors of multiple coding units in the current image for a 64×64 coding unit size, the 2N×N motion vector determination unit 132 may determine motion vectors of multiple coding units in the current image for a 64×32 coding unit size, and the N×2N motion vector determination unit 133 may determine motion vectors of multiple coding units in the current image for a 32×64 coding unit size. In a second iteration, the N×N motion vector determination unit 131 may determine motion vectors of multiple coding units in the current image for a 32×32 coding unit size, the 2N×N motion vector determination unit 132 may determine motion vectors of multiple coding units in the current image for a 32×16 coding unit size, and the N×2N motion vector determination unit 133 may determine motion vectors of multiple coding units in the current image for a 16×32 coding unit size. In a third iteration, the N×N motion vector determination unit 131 may determine motion vectors of multiple coding units in the current image for a 16×16 coding unit size, the 2N×N motion vector determination unit 132 may determine motion vectors of multiple coding units in the current image for a 16×8 coding unit size, and the N×2N motion vector determination unit 133 may determine motion vectors of multiple coding units in the current image for an 8×16 coding unit size. In a fourth iteration, the N×N motion vector determination unit 131 may determine motion vectors of multiple coding units in the current image for an 8×8 coding unit size, the 2N×N motion vector determination unit 132 may determine motion vectors of multiple coding units in the current image for an 8×4 coding unit size, and the N×2N motion vector determination unit 133 may determine motion vectors of multiple coding units in the current image for a 4×8 coding unit size.

Hereinafter, a coding unit that is the target of motion estimation is referred to as a “target coding unit”. The target coding unit may be the LCU of multiple coding units constituting the current image.

For example, the target coding unit may be each of multiple coding units constituting the current image. Alternatively, the target coding unit may be coding units selected according to a predetermined condition from among multiple coding units constituting the current image. Alternatively, the target coding unit may be a Larger Coding Unit (LCU) of multiple coding units constituting the current image.

At step 250, the selection unit 140 may determine the attribute value of the target coding unit in the current image. Here, the attribute value may be the SAD of the target coding unit.

When the SAD of the target coding unit is determined, technology other than the above-described steps may be used. For example, a method that is used to determine motion vectors or SAD values of coding units in AVC and HEVC may be used to determine the SAD of the target coding unit.

As described above, at step 240, motion vectors of multiple coding units in the current image may be determined for multiple coding unit sizes. Among multiple coding units having respective coding unit sizes, a coding unit corresponding to the target coding unit may be present. Here, the corresponding coding unit may be a coding unit, the location of which overlaps at least partially that of the target coding unit.

The selection unit 140 may select a minimum motion vector from among motion vectors of a plurality of coding units corresponding to the target coding unit, out of multiple coding units having multiple coding unit sizes in the current image. A SAD corresponding to the selected minimum motion vector may be the SAD of the target coding unit. In other words, the selection unit 140 may determine the SAD of the target coding unit by determining a minimum motion vector among the motion vectors of coding units corresponding to the target coding unit of multiple coding units having multiple coding unit sizes in the current image.

As described above, the motion vector of the corresponding coding unit may correspond to a minimum SAD among the SAD values of the coding unit. Therefore, multiple motion vectors may be determined based on the SAD values of multiple coding units in the current image.

Further, the selection unit 140 may determine the coding unit size of the target coding unit. The coding unit sizes of coding units corresponding to the target coding unit may be different from each other. The coding unit size of a coding unit having a minimum motion vector among the coding units corresponding to the target coding unit may be determined to be the coding unit size of the target coding unit.

In other words, the selection unit 140 may determine a candidate coding unit having a minimum motion vector, among candidate coding units having different coding unit sizes, to be the target coding unit.

Further, the selection unit 140 may determine multiple target coding units of the current image. Each of multiple target coding units may be a coding unit selected using the above-described minimum motion vector. By the selection unit 140, multiple target coding units constituting the current image may be determined. For example, multiple target coding units may be LCUs in the current image.

At step 260, the average SAD calculation unit 150 may calculate the average SAD of the current image.

The average SAD of the current image may be the average of SAD values of multiple LCUs in the current image. Alternatively, the average SAD of the current image may be the average of SAD values of multiple target coding units in the current image. Alternatively, the average SAD of the current image may be the average of SAD values of multiple LCUs in the current image.

At step 270, the determination unit 160 may determine the number of one or more previous images to be used for motion estimation of each target coding unit, based on the SAD of the target coding unit and the average SAD of the current image. Here, the one or more previous images may be reference images of the target coding unit.

At step 270, the motion estimation apparatus 100 may adaptively select the number of reference images to be used for motion estimation of the target coding unit and may adaptively adjust the amount of access to the external memory to use the reference images.

The determination unit 160 may determine the number of one or more previous images to be used for motion estimation of each target coding unit, based on a comparison between the SAD of the target coding unit and the average SAD of the current image.

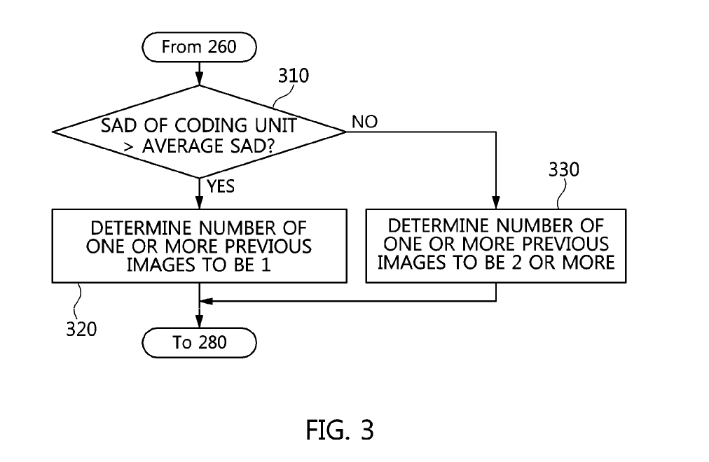

The method for determining the number of one or more previous images to be used for motion estimation of the target coding unit will be described in detail later with reference to FIG. 3.

At step 280, the motion estimation unit 170 may estimate the motion of the target coding unit using one or more previous images.

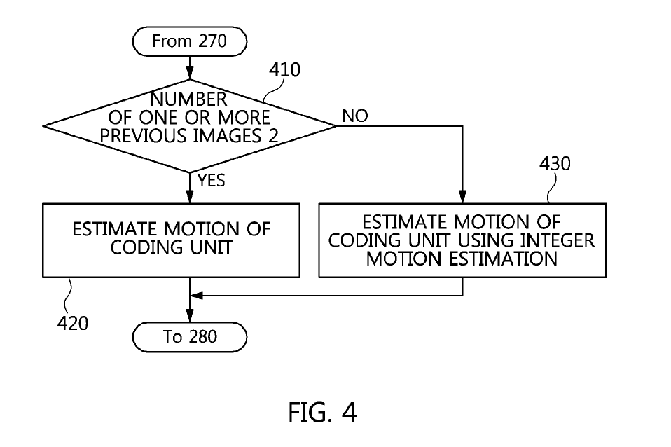

The method for estimating the motion of the target coding unit according to an embodiment will be described in detail later with reference to FIG. 4.

FIG. 3 is a flowchart showing a method for determining the number of one or more previous images to be used for motion estimation of a coding unit according to an embodiment.

Step 270 described above with reference to FIG. 2 may include the following steps 310, 320, and 330.

At step 310, the determination unit 160 determines whether the SAD of the target coding unit is greater than the average SAD of the current image. When the SAD of the target coding unit is greater than the average SAD of the current image, the process proceeds to step 320. In contrast, when the SAD of the target coding unit is less than or equal to the average SAD of the current image, the process proceeds to step 330.

At step 320, when the SAD of the target coding unit is greater than the average SAD of the current image, the determination unit 160 may determine the number of one or more previous images, which are to be used for motion estimation of the target coding unit, to be 1.

When the SAD of the target coding unit is greater than the average SAD of the current image, it may be considered that similarity between the current image and the previous image is relatively high. In other words, when the SAD of the target coding unit is greater than the average SAD of the current image, the determination unit 160 may determine that the current image and the previous image are similar to each other. When the similarity between the current image and the previous image is greater than a predetermined level, based on a preset condition, the determination unit 160 may determine the number of one or more previous images, which are to be used for motion estimation of the target coding unit, to be 1. Here, the preset condition may include a comparison between the SAD of the target coding unit and the average SAD of the current image.

At step 330, when the SAD of the target coding unit is less than or equal to the average SAD of the current image, the determination unit 160 may determine the number of one or more previous images, which are to be used for motion estimation of the target coding unit, to be 2 or more.

When the SAD of the target coding unit is less than or equal to the average SAD of the current image, it may be considered that similarity between the current image and the previous image is relatively low. In other words, when the SAD of the target coding unit is less than or equal to the average SAD of the current image, the determination unit 160 may determine that the current image and the previous image are not similar to each other. When the similarity between the current image and the previous image is less than or equal to a predetermined level, based on a preset condition, the determination unit 160 may determine the number of one or more previous images, which are to be used for motion estimation of the target coding unit, to be 2 or more. Here, the preset condition may include a comparison between the SAD of the target coding unit and the average SAD of the current image.

Therefore, when the SAD of the target coding unit is greater than the average SAD of the current image, one previous image may be used for the motion estimation of the target coding unit. Further, when the SAD of the target coding unit is less than or equal to the average SAD of the current image, two or more previous images may be used for motion estimation of the target coding unit.

FIG. 4 is a flowchart showing a method for estimating the motion of a target coding unit using one or more previous images according to an embodiment.

Step 280 described above with reference to FIG. 2 may include steps 410, 420, and 430.

At step 410, the motion estimation unit 170 may check whether the number of one or more previous images to be used for motion estimation of the target coding unit is 2 or more. When the number of one or more previous images to be used for motion estimation of the target coding unit is 2 or more, the process proceeds to step 430. In contrast, when the number of one or more previous images to be used for motion estimation of the target coding unit is 1, the process proceeds to step 420.

At step 420, the motion estimation unit 170 may estimate the motion of the target coding unit using one previous image.

At step 430, the motion estimation unit 170 may estimate the motion of the target coding unit using integer motion estimation for two or more previous images.

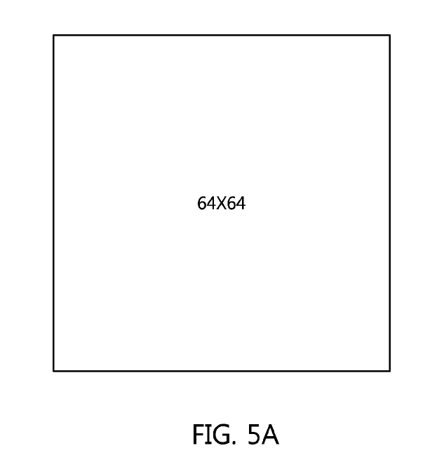

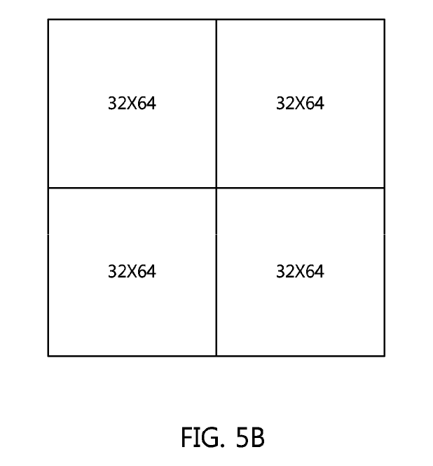

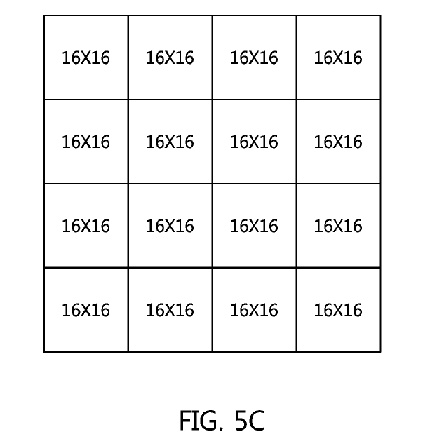

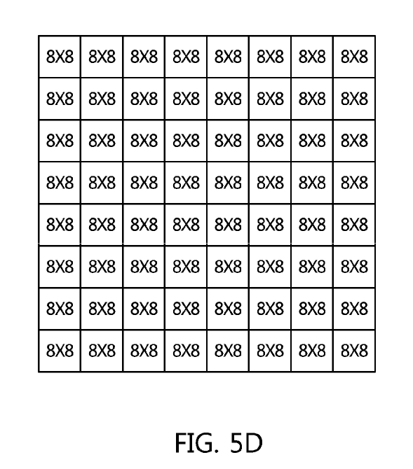

FIGS. 5A to 5D illustrate a current image composed of coding units having an N×N coding unit size according to an embodiment.

The illustrated coding units having the N×N coding unit size may be processed by the N×N processing element array 121 and the N×N motion vector determination unit 131.

FIG. 5A illustrates a current image composed of a coding unit having a 64×64 coding unit size according to an embodiment.

FIG. 5B illustrates a current image composed of coding units having a 32×32 coding unit size according to an embodiment.

FIG. 5C illustrates a current image composed of coding units having a 16×16 coding unit size according to an embodiment.

FIG. 5D illustrates a current image composed of coding units having an 8×8 coding unit size according to an embodiment.

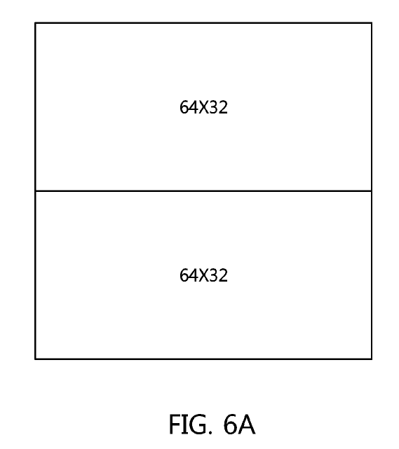

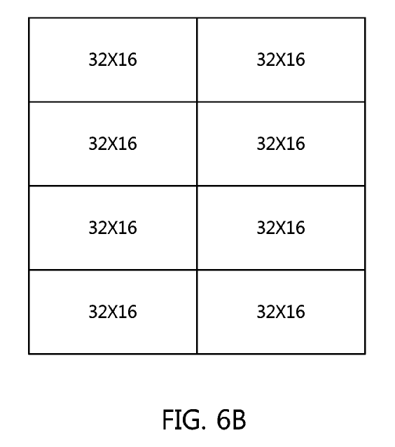

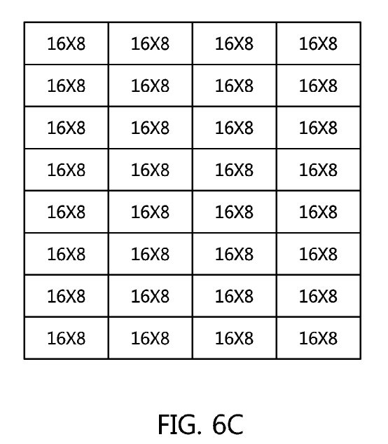

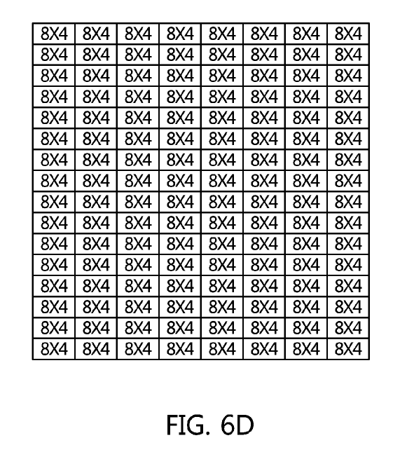

FIGS. 6A to 6D illustrate a current image composed of coding units having a 2N×N coding unit size according to an embodiment.

The illustrated coding units having the 2N×N coding unit size may be processed by the 2N×N processing element array 122 and the 2N×N motion vector determination unit 132.

FIG. 6A illustrates a current image composed of coding units having a 64×32 coding unit size according to an embodiment.

FIG. 6B illustrates a current image composed of coding units having a 32×16 coding unit size according to an embodiment.

FIG. 6C illustrates a current image composed of coding units having a 16×8 coding unit size according to an embodiment.

FIG. 6D illustrates a current image composed of coding units having an 8×4 coding unit size according to an embodiment.

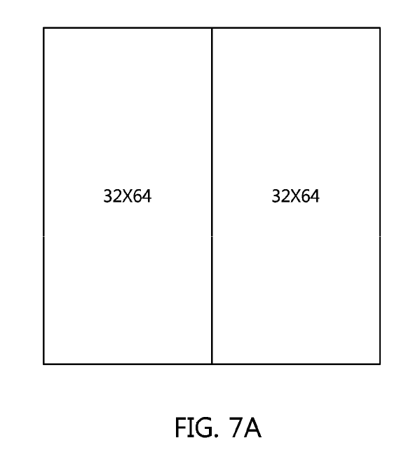

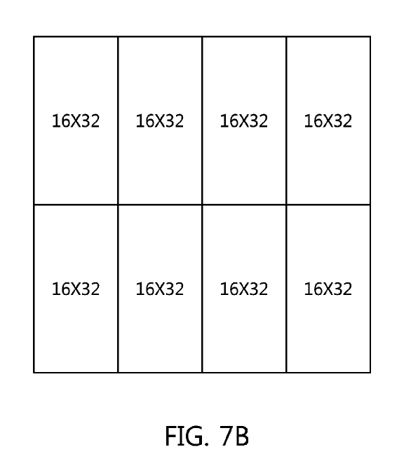

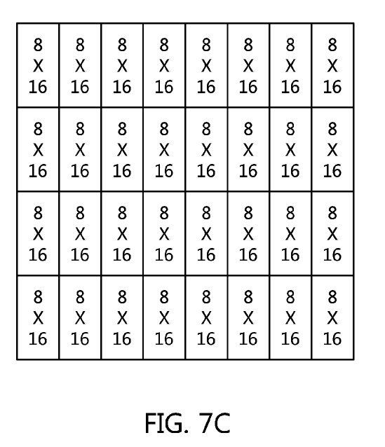

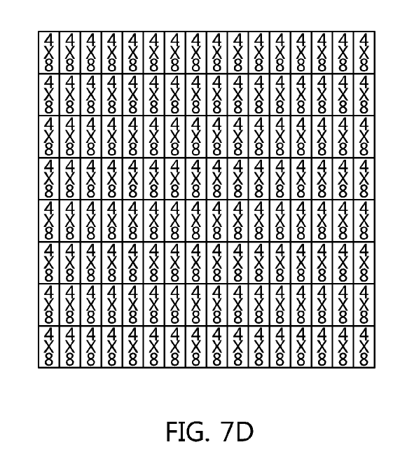

FIGS. 7A to 7D illustrate a current image composed of coding units having an N×2N coding unit size according to an embodiment.

The illustrated coding units having the N×2N coding unit size may be processed by the N×2N processing element array 123 and the N×2N motion vector determination unit 133.

FIG. 7A illustrates a current image composed of coding units having a 32×64 coding unit size according to an embodiment.

FIG. 7B illustrates a current image composed of coding units having a 16×32 coding unit size according to an embodiment.

FIG. 7C illustrates a current image composed of coding units having a 8×16 coding unit size according to an embodiment.

FIG. 7D illustrates a current image composed of coding units having a 4×8 coding unit size according to an embodiment.

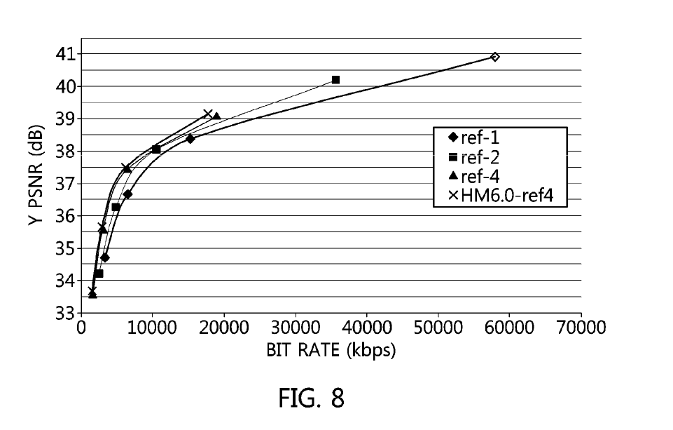

FIG. 8 illustrates the results of simulation depending on the number of reference images according to an embodiment.

In FIG. 8, an x axis indicates bit rate. The unit of numerals on the x axis may be kilobits per second (kbps). A y axis indicates Peak Signal-to-Noise Ratio (PSNR). The unit of numerals on the y axis may be a decibel (dB).

In FIG. 8, “ref-1”, “ref-2” and “ref-4” denote the cases where the number of reference images is 1, 2, and 4, respectively. Further, “HM6.0-ref4” indicates the case where the number of reference images is 4 in HEVC test model (HM) 6.0. As shown in the drawing, in general, as the number of reference images is increased, higher Y PSNR may be acquired. For example, at a bit rate of 3.5 Mbps, a difference of 0.5 dB may occur between the image quality obtained when one previous frame (image) is used as a reference frame, and the image quality obtained when four previous frames are used as reference frames.

Therefore, the motion estimation apparatus 100 according to the embodiment may provide high image quality compared to other motion estimation methods that use only a single reference image, and may especially reduce the memory bandwidth required to access the external memory by adaptively determining the number of reference images.

The method according to the embodiment may be implemented as a program that can be executed by various computer means. In this case, the program may be recorded on a computer-readable storage medium. The computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and vice versa.

There are provided the motion estimation apparatus and method, which can improve the quality of a video while using relatively low memory bandwidth by adaptively selecting the number of reference images.

There are provided the motion estimation apparatus and method, which efficiently read previous images required for motion estimation by adaptively selecting the number of reference images.

As described above, although the embodiments have been described with reference to a limited number of embodiments and drawings, those skilled in the art will appreciate that various changes and modifications are possible from the above descriptions. For example, even if the above-described technologies are performed in a sequence differing from that of the described method, and/or components such as a system, a structure, a device, and a circuit are coupled or combined in a way differing from that of the described method or are replaced with or substitute other components or equivalents, suitable results can be achieved.

Therefore, it should be understood that other embodiments and examples and equivalents of the accompanying claims belong to the scope of the accompanying claims.

What is claimed is:

1. A motion estimation apparatus, comprising:
a selection unit for determining an attribute value of a coding unit in a current image; and
a determination unit for determining a number of one or more previous images to be used for motion estimation of the coding unit, based on the attribute value of the coding unit.

2. The motion estimation apparatus of claim 1, wherein the attribute value is a Sum of Absolute Difference (SAD) of the coding unit.

3. The motion estimation apparatus of claim 2, wherein the determination unit determines the number of one or more previous images to be used for motion estimation of the coding unit, based on the SAD of the coding unit.

4. The motion estimation apparatus of claim 2, further comprising an average SAD calculation unit for calculating an average SAD of the current image,
wherein the determination unit determines the number of one or more previous images to be used for motion estimation of the coding unit, based on a comparison between the SAD of the coding unit and the average SAD of the current image.

5. The motion estimation apparatus of claim 4, wherein the determination unit is configured to, when the SAD of the coding unit is greater than the average SAD of the current image, determine the number of one or more previous images to be used for motion estimation of the coding unit to be 1, and when the SAD of the coding unit is less than or equal to the average SAD of the current image, determine the number of one or more previous images to be used for motion estimation of the coding unit to be 2 or more.

6. The motion estimation apparatus of claim 2, further comprising a motion vector determination unit for generating multiple motion vectors related to the coding unit,
wherein the selection unit determines the SAD of the coding unit by selecting a minimum motion vector, from among motion vectors of a plurality of coding units corresponding to the coding unit, out of multiple coding units having multiple coding unit sizes in the current image.

7. The motion estimation apparatus of claim 6, wherein the motion vector determination unit determines, in parallel, motion vectors of multiple coding units in the current image, for two or more of multiple different coding unit sizes.

8. The motion estimation apparatus of claim 6, further comprising a processing element array for calculating SAD values of multiple coding units in the current image, for multiple different coding unit sizes,
wherein the multiple motion vectors are determined based on the SAD values of the multiple coding units.

9. The motion estimation apparatus of claim 8, wherein the processing element array calculates, in parallel, SAD values of multiple coding units in the current image, for two or more of the multiple different coding unit sizes.

10. The motion estimation apparatus of claim 8, wherein the processing element array calculates, in parallel, SAD values of multiple coding units in the current image, for N×N, 2N×N, and N×2N coding unit sizes of the multiple different coding unit sizes.

11. The motion estimation apparatus of claim 10, wherein:
the N×N coding unit size includes 64×64, 32×32, 16×16, and 8×8 sizes,
the 2N×N coding unit size includes 64×32, 32×16, 16×8, and 8×4 sizes, and
the N×2N coding unit size includes 32×64, 16×32, 8×16, and 4×8 sizes.

12. The motion estimation apparatus of claim 8, wherein the processing element array comprises:
an N×N processing element array for calculating SAD values of multiple coding units in the current image for an N×N coding unit size;
a 2N×N processing element array for calculating SAD values of multiple coding units in the current image for a 2N×N coding unit size; and
an N×2N processing element array for calculating SAD values of multiple coding units in the current image for an N×2N coding unit size.

13. The motion estimation apparatus of claim 11, wherein the N×N processing element array, the 2N×N processing element array, and the N×2N processing element array calculate, in parallel, SAD values for the N×N, 2N×N, and N×2N coding unit sizes.

14. The motion estimation apparatus of claim 2, further comprising:
current image memory for storing the current image; and
previous image memory for storing a previous image that is an image previous to the current image,
wherein the SAD values are generated based on the current image and the previous image.

15. The motion estimation apparatus of claim 14, further comprising an address generation unit for determining a memory address of the previous image.

16. The motion estimation apparatus of claim 1, further comprising a motion estimation unit for estimating motion of the coding unit using the one or more previous images.

17. The motion estimation apparatus of claim 16, wherein the motion estimation unit estimates motion of the coding unit using integer motion estimation if the number of one or more previous images is two or more.

18. A method for determining a number of one or more previous images to be used for motion estimation of a coding unit, comprising:
determining a SAD of a coding unit in a current image;
calculating an average SAD of the current image; and
determining a number of one or more previous images to be used for motion estimation of the coding unit, based on the SAD of the coding unit and the average SAD of the current image.

19. The method of claim 18, wherein when the SAD of the coding unit is greater than the average SAD of the current image, one previous image is used for motion estimation of the coding unit, whereas when the SAD of the coding unit is less than or equal to the average SAD of the current image, two or more previous images are used for motion estimation of the coding unit.

20. A motion estimation method, comprising:
determining an attribute value of a coding unit in a current image;
determining a number of one or more previous images to be used for motion estimation of the coding unit, based on the attribute value of the coding unit; and
estimating motion of the coding unit using the one or more previous images.
